(19) United States
(12) Patent Application Publication
(10) Pub. No.: US 2012/0224900 A1
(43) Pub. Date: Sep. 6, 2012

(54) IMAGE FORMING APPARATUS

(75) Inventors: Hiroyuki SAITO, Tokyo (JP); Hiroshi AKITA, Tokyo (JP); Tomohiro KAWASAKI, Kanagawa (JP); Eri YAGI, Kanagawa (JP)

(73) Assignee: KONICA MINOLTA BUSINESS TECHNOLOGIES, INC., Tokyo (JP)

(21) Appl. No.: 13/404,059

(22) Filed: Feb. 24, 2012

(30) Foreign Application Priority Data
Mar. 3, 2011 (JP) JP2011-046020

(51) Int. Cl. G03G 15/00

(52) U.S. Cl. 399/388

(57) ABSTRACT

An image forming apparatus includes: an image carrier; a developing section which develops the latent image on the image carrier with a toner to form an unfixed toner image; a transfer section which transfers the unfixed toner image to a transfer material; and a resilient roller member provided on a position downstream of the developing section and upstream of the transfer section in a rotational direction of the image carrier, which applies pressure to the image carrier and rotates in the same direction as the image carrier, wherein when a contact portion of the resilient roller member with the image carrier becomes a non-contact state as the rotation advances, the resilient roller member maintains a deformed state caused by the pressure, and the resilient roller member restores from the deformed state before the contact portion again comes into contact with the image carrier.

This application is based on Japanese Patent Application No. 2011-046020 filed on Mar. 3, 2011, which is incorporated hereinto by reference.

### BACKGROUND OF THE INVENTION

The present invention relates to an image forming apparatus such as a copying machine, printer, or a multifunction peripheral, that forms a toner image using an electro-photographic method.

Image forming apparatuses are well known that prepare a toner image according to an original document or an image data on the surface of a photoreceptor drum which is an image carrier by carrying out the processing of charging, exposure, and development, and after that, either transfer the toner image on a transfer material such as paper, or else first transfer onto an intermediate image transfer material and then carry out secondary transfer onto a transfer material.

There are strong demands of high productivity, high resolution, and high image quality on such image forming apparatuses, and also high reliability and image stability are required along with these demands.

The factors that can be considered to be related to high resolution and high image quality are the developing process step and the transfer process step. In the developing process step, for example, a two-component developing agent containing a magnetic carrier (hereinafter referred to merely as carrier) and a non-magnetic carrier (hereinafter referred to merely as toner) is made to adhere magnetically on the surface of a developing agent carrier and conveyed to the developing section. Next, during the developing processing, a bias voltage having a DC voltage (same polarity as that of the toner charging electrode) superimposed on an AC voltage is applied to the developing agent carrier thereby causing the developing agent to fly and carrying out reversal development. The toner image adhered to the photoreceptor drum due to this developing process is present on the photoreceptor drum in a stable state due to the electrostatic adhesive force between the toner particles and the photoreceptor drum with the effect of the electrostatic repulsive force between toner particles. However, for example, even if the toner image or the toner particles (both may be referred to hereinafter as toner) are exhibiting a stable state on the photoreceptor drum, it is not possible to say that this means that there is a stable state for the transfer process step.

For example, in the electro-photographic process, although in the transfer process step it is possible to form a uniform electric field between a corotron electrode or a roller electrode to which a transfer bias has been applied and the photoreceptor drum, the uniform electric field at this time is not necessarily an appropriate electric field for the toner on the photoreceptor drum.

In other words, in a developing device having a developing agent carrier, the toner is stirred and mixed with the carrier and acquires a prescribed charge, but since there are variations in the toner particle diameter, or carrier deterioration, or the state of adhesion of additives, or the like, the individual toner particles are not uniformly charged. Next, during the developing process, due to the selectivity of development, a phenomenon occurs in which the priority is high of a toner with a high amount of charge (heavily charged toner) for use in development and the priority is low of a toner with a low amount of charge (lightly charged toner) for use in development. For example, in the developing process of a wide image area such as a solid image, first the heavily charged toners are used for development and the lightly charged toners are used later to compensate for insufficient development. Further, in the development process of small areas such as thin lines, in the extreme case, only the heavily charged toners are used for development and the development process is ended. In this manner, the toner image formed on the photoreceptor drum is a collection of toners having different amounts of charge. Because of this, toner scattering and image fluctuations occur in the transfer process step, even if a uniform electric field is formed between the electrode and the photoreceptor drum, since the electric field is not appropriate for the individual toners. In other words, this is because the optimum transfer starting electric field varies depending on the amount of charge, particle diameter, condition of restricting the electric field due to the latent image of the individual toner. In this manner, since the optimum conditions are different for the developing process step (developing process) and the transfer process step (transfer process), when the toner image on the photoreceptor drum comes close to the transfer section, the toner flies from the photoreceptor drum towards the transfer material, and deteriorates the image as splashing or scattered transfer.

In recent years, image forming apparatuses have been proposed with which it is possible to obtain high quality images without roughness and with a uniform density by processing the toner image formed on the image carrier and then transferring the toner image onto the transfer material. More specifically, for correcting the toner image formed on the image carrier image correction members are provided in close proximity with the image carrier on the downstream side of the developing region where the developing agent carrier and the image carrier are opposite to each other, and also on the upstream side of the developing region where the developing agent carrier and the image carrier are opposite to each other. In addition, this is a configuration that provides not only a unit for forming an electric field between the two image correction members and the image carrier, but also a unit for removing the toner on the image correction members (see, for example, Japanese Patent Application Publication No. 2008-152300).

Although it is possible to remove the excess toner in the toner image using the electric field effect using the image correction members in the technology disclosed in Japanese Patent Application Publication No. 2008-152300, this is realized based on the presumption that the image correction members are not contacting the image carrier as described above, and the effect thereof is limited.

### SUMMARY OF THE INVENTION

A purpose of the present invention is to provide an image forming apparatus having a configuration with which it is possible to prevent dust or image fluctuations that occur at the time of transfer by contacting and pressing the toner image after developing but before transferring.

The purpose of the present invention can be achieved by the following configuration requirement&

1. To achieve at least one of the abovementioned object, an image forming apparatus reflecting one aspect of the present invention, has: an image carrier, a developing section that develops using a toner a latent image formed on the surface of the image carrier and forms an unfixed toner image, a transfer section that transfers onto a transfer material the unfixed toner image formed on the surface of the image carrier, and a resilient roller member provided on the downstream side of the developing section in the direction of rotation of the image carrier, and also, so as to press against the image carrier at an upstream position than the transfer section, and so as to rotate in the same direction as that of the image carrier, wherein the resilient roller member is configured so that, at the time that the contact portion of the resilient roller member with the image carrier goes into the non-contacting state due to rotation, not only the deformed state caused by pressure is maintained but also recovery is made from the deformed state caused by pressure before the contact portion contacts the image carrier again.

2. In the image forming apparatus of 1 above, it is preferable that the resilient roller member is configured so that, at the time that the contact portion of the resilient roller member with the image carrier contacts the image carrier again due to rotation, recovery of more than or equal to a prescribed amount is made from the deformed state caused by pressure.

3. In the image forming apparatus of 2 above, it is preferable that the recovery from the deformed state caused by pressure of the contact portion with the image carrier is configured so that the deformation caused by pressure immediately after recovering from the state of pressing against the image carrier is recovered by 80% or more at the time of contacting the image carrier again.

4. In the image forming apparatus of 1 above, it is preferable that the resilient roller member is configured so that, at the time that the contact portion of the resilient roller member with the image carrier goes into the non-contacting state due to rotation, recovery of less than or equal to a prescribed amount is made from the deformed state caused by pressure.

5. In the image forming apparatus of 1 above, it is preferable that the recovery from the deformed state caused by pressure of the contact portion with the image carrier is configured so that the deformation caused by pressure immediately after recovering from the state of pressing against the image carrier is recovered by 10% or less.

6. In the image forming apparatus of 1 above, it is preferable that the resilient roller member has a modulus of resilience of 5 to 25%.

7. In the image forming apparatus of 1 above, it is preferable that a bias potential with the same polarity as that of the toner of the unfixed toner image is applied to the resilient roller member.

8. In the image forming apparatus of 1 above, it is preferable that the resilient roller member is selectively held between the position of pressing against the image carrier and the retracting position of releasing the pressure.

### BRIEF DESCRIPTION OF THE DRAWINGS

FIG. 1 is an outline diagram showing the configuration of an image forming apparatus which is a digital color copying machine.

FIG. 2 is a schematic partially enlarged view diagram for explaining the position and the like of a resilient roller (also referred to as a resilient roller member).

FIG. 3 is a schematic partially enlarged view diagram showing the pressed state of the pressing portion between the resilient roller and the photoreceptor drum in FIG. 2.

FIG. 4 is a schematic diagram for explaining the configuration of applying a bias voltage to the resilient roller.

FIG. 5 is an outline diagram for explaining the installation position of a reflection type laser distance sensor for measuring the amount of depression of a specific site in the circumferential surface of the resilient roller.

### DETAILED DESCRIPTION OF THE PREFERRED EMBODIMENT

A preferred embodiment of the present invention is described in the following with reference to the drawings.

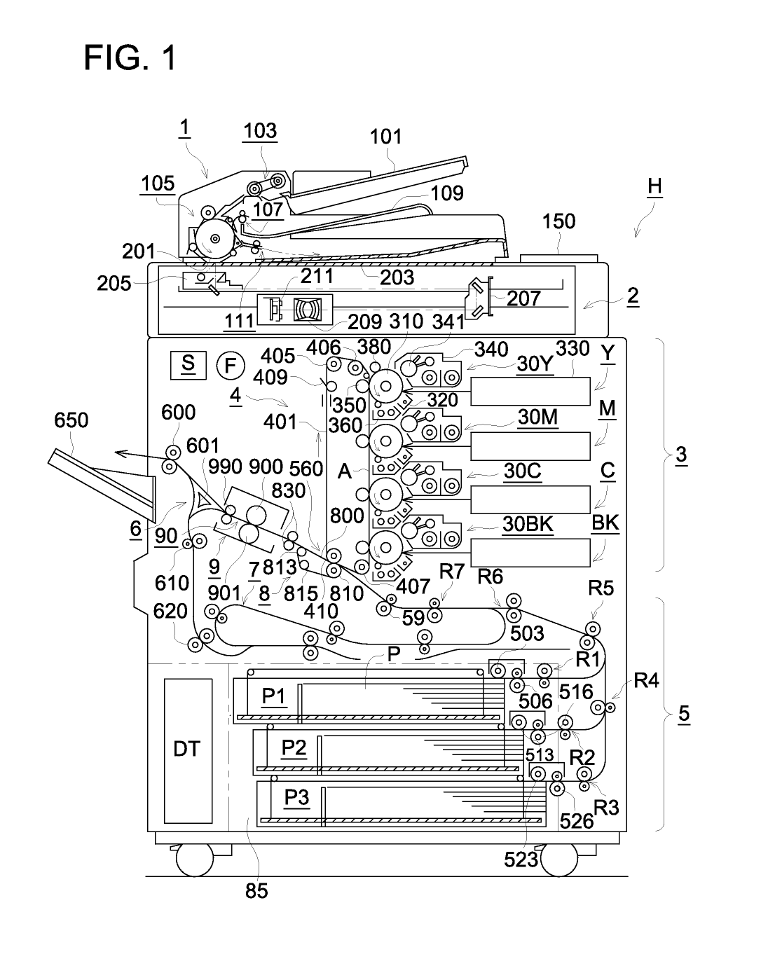

FIG. 1 is an outline diagram showing the configuration of an image forming apparatus which is a digital color copying machine.

The image forming apparatus H shown in the figure has an automatic document feeder above, and has inside an image reading section 2, an image forming section 3, a belt installation section for a belt unit 4, a sheet feeding section 5, an inverting sheet discharging and sheet re-feeding section 6, an ADU 7 which is an inverting conveying section, and a fixing apparatus 9.

The automatic document feeder 1 has a document placement table 101, a document separating section 103, a document conveying section 105, a document discharging section 107, a document discharging tray 109, and a document inverting section 111. A document (not shown in the figure) on the document placement table 101 is separated into one sheet at a time by the document separating section 103, and is conveyed to the image reading position via the document conveying section 105. The document reading position is provided below the document conveying section 105, the image of the document is read via a slit 201 constituting an image reading section 2, and the read-out document is discharged on to the document discharging tray 109 by the document discharging section 107.

Further, in the duplex image recording mode, after the document whose one side has been read is gripped by the document inverting section 111, the document is conveyed in the inverting direction due to the reverse rotation of that document inverting section 111 and is again guided to the document reading position, and is finally discharged on to the document discharging tray 109. Numeral 150 is an operation and display section that includes various operation buttons and a display section, and is provided with an image forming start button (Print button), ten keys for setting the number of sheets of image formation, and also a liquid crystal display and selection section used for selecting the image forming mode (single-sided mode, duplex mode), density adjustment, or magnification adjustment. In the following, for the same of convenience in explaining, the operation and display section 150 may be referred to merely as the display section 150.

The image reading section 2 has a slit 201, a first mirror unit 205, a second mirror unit 207, an imaging lens 209, and a line-shaped imaging device 211 (hereinafter called a CCD) which obtains image information by photoelectric conversion of the optical image imaged by the imaging lens 209. The image information, after appropriate image processing is carried out, is first accumulated in the memory inside a control section S to be described later. The image information of different colors read out by the image reading section 2 is read out from the memory successively and is respectively input as electrical signals to the exposure optical systems of the different colors.

The image forming section 3 has four sets of image forming units 30 (30Y, 30M, 30C, and 30K) of the colors yellow (Y), magenta (M), cyan (C), and black (BK) that form toner images according to the color resolved image on the image carrier to be described later. Each image forming unit 30 has a photoreceptor drum 310 as an image carrier, a charger 320, an exposure optical system 330 which is an image writing section, a developing apparatus 340, a transfer section 350, and a cleaning member 360, and the like. In the figure, reference symbols are assigned only to the members constituting the yellow image forming unit, and the reference symbols have been omitted in the other image forming units because they have basically the same configuration. Further, the resilient roller (also referred to as the resilient roller member) 380 to be described later has been omitted in the image forming units of magenta (M), cyan (C), and black (BK).

The developing apparatus 340 constituting the developing section (reference symbol not assigned) has a developing agent carrier 341, and also stores a developing agent including a carrier (magnetic carrier) and a toner (non-magnetic toner) of a different color for different developing apparatuses. The developing agent carrier 341 is constituted from a hollow roller the inside of which is provided with a plurality of magnetic poles at fixed positions along the inner circumferential surface of the roller. In other words, during the rotational operation of the developing agent carrier 341, the plurality of magnetic poles have the function of causing magnetic adhesion of the developing agent on the circumferential surface of that developing agent carrier 341 and guiding the developing agent to the developing area, and after the developing area has been passed, the function of automatically removing the developing agent from the circumferential surface of the developing agent carrier 341. Further, although not shown in the figure, a bias power supply is connected to the developing agent carrier 341, and during development, a development bias voltage in which an AC voltage is superimposed on a DC voltage is applied thereto.

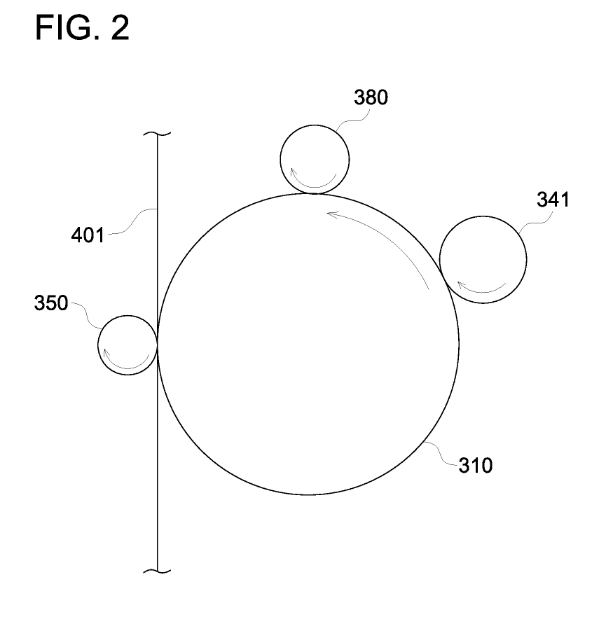

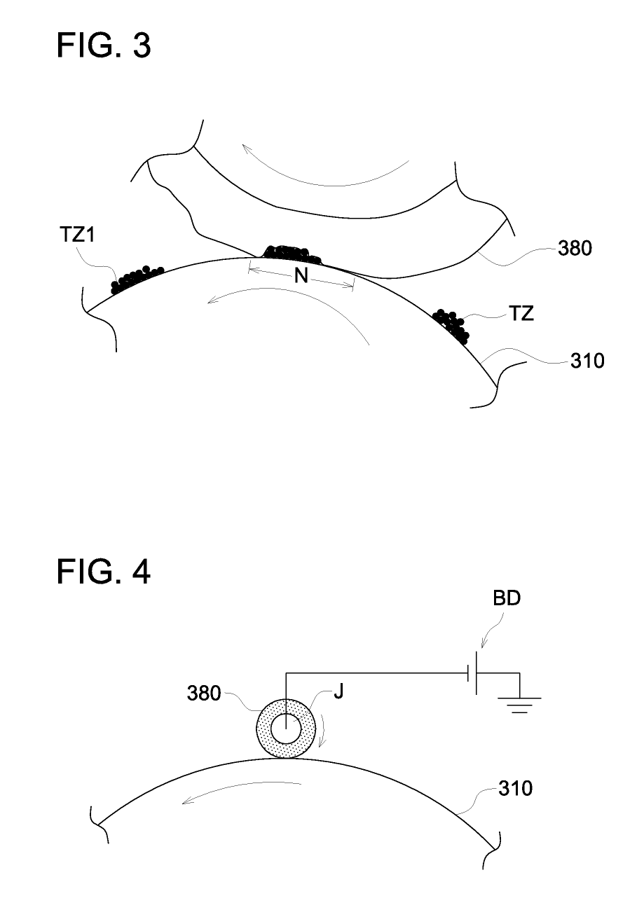

A transfer section 350 constituting the transfer section (no reference symbol assigned) is constituted from a roller, which is in the state of pressing against the photoreceptor drum 310 via an intermediate image transfer belt 401 to be described later, and during the transfer operation, a transfer bias voltage is applied from a transfer bias power supply not shown in the figure. Further, 380 is a resilient roller provided at a position on the downstream side of the developing section in the direction of rotation of the photoreceptor drum 310, and also, on the upstream side of the transfer section (see FIG. 2). FIG. 2 is a schematic partially enlarged view diagram for explaining the position and the like of a resilient roller. Further, the resilient roller 380 is provided so that it can press against the photoreceptor drum 310 or can be released from that pressing state. Releasing the pressing state is effective for avoiding the following phenomenon. That is, when pressure is applied for a long time at a specific location on the circumferential surface of the resilient roller 380, the time required for recovering from the deflected state becomes longer compared to that from the state during continuous use. In addition, restarting the drive after stopping in the pressed state for a long time is not preferable because pitch fluctuations will be generated in the image. Because of this, at the time of stopping a job, switching off the power, or the like, the resilient roller 380 is made to recede to a reacted position in order to release the state of pressing against the photoreceptor drum 310, and because of this, it is possible to maintain in a stable manner the performance as a resilient roller 380 of the present invention. Further, the resilient roller 380 in the in the pressed state during operation has the role of crushing the toner image (for example a toner image with a plurality of superimposed layers of toners) formed on the photoreceptor drum 310 because of rotating in the same direction and at the same speed (same line velocity) as the photoreceptor drum 310 as seen at the pressing portion (see FIG. 3). FIG. 3 is a schematic partially enlarged view diagram showing the pressed state of the pressing portion between the resilient roller 380 and the photoreceptor drum 310 in FIG. 2. In the following, for the sake of convenience, the pressing portion formed by the resilient roller 380 and the photoreceptor drum 310 may be referred to as the nipping portion, and also, the pressed state as the nipping state, and pressing as nipping. As is shown in FIG. 3, the toner image TZ carried by the photoreceptor drum 310 is nipped in the nipping portion between the photoreceptor drum 310 and the resilient roller 380. Next, when nipping is released, the toner image TZ before nipping is changed and formed into a toner image TZ1 allei nipping with the bulges therein having been flattened and is then conveyed towards the transfer section. On the other hand, the circumferential surface of the resilient roller 380 deformed by nipping with the photoreceptor drum 310, within one revolution of the roller during until entering again into the nipped state with the photoreceptor drum 310, recovers to a state in which the desired purpose can be achieved. For example, the configuration is such that recovery is made of a deflection change ratio of 80% or more. The deflection change ratio in the present patent specification is expressed by the amount of recovery with respect to an amount of pressing of the resilient roller in the nipping section (which has the same meaning as the amount of digging into the photoreceptor drum 310) of 0.2 mm, and is described in detail later. Further, although the rotation of the resilient roller 380 in the present preferred embodiment is of the form in which it rotates following the rotation of the photoreceptor drum 310, it is possible to have a configuration in which the rotational drive thereof is done by a dedicated drive source. Furthermore, the resilient roller 380 has a low modulus of resilience of 5 to 25%. For example, a urethane rubber with a structure having connected air bubbles of foamed urethane, or a high-elasticity low-hardness millable type silicone material can be used as a material with a low modulus of resilience. In the present preferred embodiment, the resilient roller was constituted by providing a material obtained by dispersing a conductive material in the above material on a metallic core. Further, as the surface layer of the resilient roller 380, if, for example, a thin fluoroplastic film (PTFE) layer is provided by coating or the like, it is possible to suppress the transfer of toner from the photoreceptor drum 310, and it is possible to make the resilient roller maintain the function over a long time as a resilient roller suiting the desired purpose.

The cleaning member 360 removes the toner remaining on the photoreceptor drum 310 after transfer, and the removed toner is conveyed up to and stored in a waste toner box DT. The image forming units 30 described above are arranged along the direction of progress of one flat surface A of the intermediate transfer belt 401 in the sequence of yellow (Y), magenta (M), cyan (C), and black (BK).

An intermediate transfer belt 401 as an intermediate transfer member, supporting rollers 405, 406, and 407 over which the intermediate transfer belt 401 is suspended, and a backup roller 410 constitute the belt unit 4. The reference symbol 409 denotes a blade as a cleaning section. The intermediate image transfer belt is one onto which the toner images formed on the photoreceptor drums 310 are transferred, and from the intent of the present invention, corresponds to a transfer material in the aspect in which the toner image on the photoreceptor drum is transferred directly onto a transfer material such as paper or the like.

The reference symbol 8 denotes the secondary transfer mechanism section that transfers on to a transfer material P (described later) the toner image that is carried on the intermediate transfer belt 401. As is shown in the figure, the transfer mechanism 8 has a plurality of supporting section having rollers (supporting rollers) 813 and 815, a nipping section 810 having a roller (nipping roller), and a transfer belt 800 suspended over these sections. The nipping section 810 not only functions as a supporting section for the transfer belt 800 but also, in coordination with the opposing backup roller 410, maintains the nipping contact between the transfer belt 800 and the intermediate transfer belt 401.

A bias power supply (not shown in the figure) that outputs a voltage with a prescribed polarity (polarity opposite to the polarity of the electrostatic charge on the toner) is connected to the aforementioned nipping section 810, and the control of switching on or off the voltage is made via a control section S (to be described later). 830 is a conveying roller for feeding the transfer material P after transfer to the fixing apparatus 9. The fixing apparatus 9 has a fixing section 90 comprising a first fixing roller 900 as a first fixing member positioned so as to contact the unfixed toner image side of the transfer material P and a second fixing roller 901 as a second fixing member that rotates while nipping with the first fixing roller 900. As is well-known, a heating source (not shown in the figure) such as a halogen lamp is incorporated inside the first fixing roller 900.

The part shown on the downstream side of the fixing section 90 is a fixing section sheet discharging roller 990.

P1, P2, and P3 denote sheet feeding trays that store transfer materials P such as sheets. The issuing section is provided with sheet feeding rollers 503, 513, and 523, separation rollers 506, 516, and 526, and conveying rollers R1, R2, and R3. A transfer material P issued from these rollers is conveyed along a sheet conveying path wherein are placed the conveying rollers R5 to R7. Numeral 59 is a registration roller which is provided at a position close to the secondary transfer area 560.

The reference symbol 600 denotes a sheet discharging roller and 650 denotes a sheet discharging tray.

The reference symbol 6 is a sheet inverting discharging and re-feeding section, and can invert the transfer sheet P after fixing and discharge it to outside the apparatus. Further, in the duplex image forming mode, by guiding a transfer material P having images formed on its first surface and having been subjected to the fixing process to the registration roller 59 via the conveying rollers 610, 620, or the like, and by feeding the sheet again, image forming is done on the second surface of the transfer material P. Further, since the conveying path of the transfer material during duplex image forming is basically well known, and also, since there is no direct relationship with the present invention, detailed explanation thereof is omitted.

S is a control section including a computer, incorporates a program for machine actuation, and carries out all the controls such as the controls related to the sequence of image forming process, sheet feeding control, or the like. In other words, the control section S has a CPU that carries out computation control processing, a ROM storing various types of operation programs, and a RAM storing data of the results of computations. Further, the control section S also inputs the outputs of various sensors via an interface, and carries out drive controls of display section, drive section, and the like.

Here, the operation of an image forming apparatus having the configuration described above is described briefly. The operations of the image forming apparatus is started when a user presses the image forming start button (Start button) on the operation and display panel 150, the surface of the photoreceptor drum 310 rotating in the counterclockwise direction is charged to the prescribed polarity by the charger 320. Next, exposure is made by the exposure optical system 330 corresponding to the first color signal, that is, corresponding to the image signal of yellow (Y), and a latent image corresponding to the image of that yellow (y) color is formed on the photoreceptor drum 310. Reversal development of the latent image is carried out via the developing agent carrier 341 to which a development bias voltage has been applied, and is converted into a yellow (Y) toner image. Next, the (Y) toner image receives the nipping action of the resilient roller 380. For example, in the portion having toners where several layers of toner images are superimposed on one another, the toner images are pressed and flattened by the nipping action. After that, the toner image is transferred onto the intermediate transfer belt 401 due to the action of the transfer section 350 to which a transfer bias voltage has been applied. At this time, there is no scattering of the toner even if the image area comprising the toner image comes close to the transfer region where the transfer section 350 is present. The image formation of other color signals, which is started successively a prescribed time after the starting of the image formation of the first color, are carried out using processes similar to the above, by the image forming units 30 for the colors magenta (M), cyan (C), and black (BK).

The different toner images formed on the photoreceptor drum 310 by the respective image forming units are transferred successively so as to overlap the image area where the yellow (Y) toner image is present, and a superimposed color toner image is formed on the intermediate transfer belt 401. On the other hand, the transfer material P issued by the sheet feeding roller 503 (513, or 523) according to the image forming process would have stopped with the leading edge of the transfer material butting against the registration roller 59. Next, the transfer material P, due to the restarting rotation of the registration roller 59, is fed again at a timing overlapping the color toner image area on the intermediate transfer belt 401.

Next, the transfer material P in the secondary transfer area is pressed by both the intermediate image transfer belt 401 and the transfer belt 800 by the backup roller 410 and the nipping section 810, and during this period, the color toner image on the intermediate transfer belt 401 is transferred onto the transfer material P. The transfer material that has undergone the transfer process is gripped between the conveying rollers 830 after having been separated from the intermediate transfer belt 401, and next, while being gripped and conveyed by a fixing section 90, is heated and pressed. Next, the transfer material P is discharged over the sheet discharge tray 650 by the sheet discharge roller 600 in the selected form. These operations are repeated until the image recording of the prescribed number of sheets according to the original document is completed.

In the above configuration, it is preferable to have a configuration (see FIG. 4) in which a bias voltage with the same polarity as the toner, and also, of the same potential as the toner on the photoreceptor drum after development is applied to the resilient roller 380, and in this case, it is possible to definitely avoid the adhesion of toner from the photoreceptor drum 310 to the resilient roller. In the figure, BD denotes the roller bias power supply, and a repulsive electric field for the toner is formed between the resilient roller 380 and the photoreceptor drum 310 via a metal core J.

Next, explanations are given regarding the conditions required as a resilient roller based on results of experiments.

The different basic conditions of the related section at the time of the experiments are as follows.

Photoreceptor drum:
Drum diameter: 100 mm
Linear velocity: 400 mm/sec.

Development:
Developing agent carrier diameter: 25 mm.
Developing agent carrier linear velocity: 720 mm/sec.
Development potential: Vac 1.0 kVpp, 9 kHz square wave, Vdc −400 V applied.

Developing agent:
Ferrite coated carrier: Average particle diameter of 30 μm
Toner: Average particle diameter of 6.5 μm
Toner concentration: 7.5%.

Resilient roller:
Roller external diameter: 20 mm
Wall thickness: 6 mm
Surface layer: PTFE coated layer 2 μm
Amount of digging into the photoreceptor drum: 0.2 mm

Further, the eight types A to H shown in Table 1 were prepared as the resilient roller. That is, resilient rollers with a configuration of providing on a metal core a rubber layer having a urethane rubber with a structure configured from the connected air bubbles of foamed urethane, and resilient rollers with a configuration of providing on a metal core a layer having high-elasticity low-hardness minable type silicone material were prepared. In the table, the types A and B of the resilient roller are in effect positioned as comparison examples.

TABLE 1

| Roller type | A | B | C | D | E | F | G | H |
|---|---|---|---|---|---|---|---|---|
| Resilient material | Urethane | Silicone | Urethane | Urethane | Urethane | Urethane | Urethane | Silicone |
| | foam | | foam | foam | foam | foam | foam | |
| Resilience (%) | 50 | 30 | 25 | 20 | 17 | 13 | 8 | 5 |
| Density (kg/m³) | 40 | — | 40 | 40 | 40 | 40 | 40 | — |
| Hardness (N) | 68 | 65 | 62 | 60 | 58 | 56 | 50 | 42 |
| Volume resistivity | 10⁶ | 10⁵ | 10⁶ | 10⁶ | 10⁶ | 10⁶ | 10⁶ | 10⁵ |
| (Ω cm) | | | | | | | | |

### EXPERIMENT EXAMPLE 1

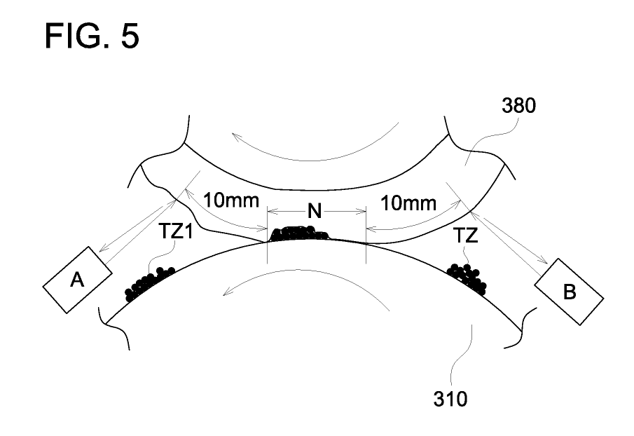

When nipping an unfixed toner image on a photoreceptor using a resilient roller, it is very important to find out the conditions so as to nip the toner uniformly, and also, at the exit of the nipping section, the resilient roller that was deformed in the nipping section remains deformed and releases the stress generated between the resilient roller and the toner image, and so that the toner does not slide in the direction of feeding of the photoreceptor drum. In other words, when it is not possible to ensure that the stress in the unfixed direction is not allowed to be generated in the unfixed toner image, or else, to release the stress well, the toner image slides in the direction of rotation of the photoreceptor drum, and the toner image gets disturbed. This phenomenon was measured using a reflection type laser distance sensor (Laser displacement meter LK-G82 manufactured by Keyence) by measuring the amount of depression at a position (position A in FIG. 5) 10 mm downstream on the peripheral surface of the resilient roller from the exit side of the nip section taking as the 0 reference the condition in which the surface of the resilient roller is in the state of not nipping the photoreceptor drum. At the same time, the image quality after transfer was investigated closely, and conditions were found out in which there was no generation of image disturbance. FIG. 5 is a drawing for showing the sensor position with respect to the resilient roller 380. Further, the amount of nipping (amount of digging) of the photoreceptor drum by the resilient roller was 0.2 mm, and the width of nipping at that time was 2.6 mm, and the height of the toner layer on the photoreceptor drum was 10 μm.

The results are shown in Table 2. The image quality was evaluated by visual inspection in terms of four levels.

TABLE 2

| Roller type | A | B | C | D | E | F | G | H |
|---|---|---|---|---|---|---|---|---|
| Resilience (%) | 50 | 30 | 25 | 20 | 17 | 13 | 8 | 5 |
| Amount of depression | 0.03 | 0.098 | 0.162 | 0.18 | 0.186 | 0.197 | 0.197 | 0.197 |
| (mm) | | | | | | | | |
| Rate of change of | 85 | 51 | 19 | 10 | 7 | 2 | 2 | 2 |
| deformation (%) | | | | | | | | |
| Image disturbance | D | D | C | B | A | A | A | A |

In Table 2, the rate of change of deformation is the restored amount with respect to the amount of digging (amount of flattening) of 0.2 mm when nipped using a roller.

Rate of change of deformation=(amount of roller nipping−amount of depression)/(amount of roller nipping)

Evaluation of image disturbance: A: 3-point characters can be read easily. B: 3-point characters can be read but some allowable dust is present. C: 3-point characters are very slightly recognizable but dust can be seen, but there is no problem with 5-point characters. D: 3-point characters are smudged by dust.

As is shown in Table 2, as a resilient roller, it is preferable that the rate of change of deformation is in the range of 25% or less but 5% or more, more preferably 20% or less but 5% or more, and most preferably 17% or less but 5% or more. The aforementioned range of 25% or less but 5% or more is treated in the present invention as a low resilience roller. Here, the reason that the lower limit or the resilience was taken as 5% is that at values lower than this the amount of deformation during nipping becomes too small, and it is not possible to form the nipping section. In the case of high resilience rollers with a resilience of 30% or more, the image disturbance was very bad, and image quality deterioration was marked. Further, in terms of the rate of change of deformation, it was found that it is preferable that the roller has a rate of change of deformation of 19% or less, more preferably 10% or less but 2% or more, and most preferably 7% or less but 2% or more.

### EXPERIMENTAL EXAMPLE 2

However, deformation occurs in the resilient roller due to nipping the photoreceptor drum. If the resilient roller in the same condition is, for example, used for nipping the next toner image, it would mean that the toner is pressed in the state in which undulations are present on the peripheral surface of the roller, and it is not possible to press the toner uniformly. In other words, undulations in the resilient roller will cause torque fluctuations of the photoreceptor drum, and as a result, the torque fluctuations appear as pitch variations in the image quality. Therefore, within the period of one revolution during which the circumferential portion of the resilient roller is released from the nipping state goes again into the state of nipping the photoreceptor drum, it is necessary to recover from the deformation to the extent that the prescribed performance can be obtained. In view of this, the distortion recovery state was measured with the three levels of linear velocity of the photoreceptor drum (which has the same meaning as the linear velocity of the roller) of 400 mm/sec, 500 mm/sec, and 600 mm/sec, and also using three types of resilient rollers with low resilience, and at the same time presence or absence of pitch variations were evaluated. In order to do this, not only the amount of depression was measured using the reflection type laser distance sensor mentioned above at a position (position B in FIG. 5) 10 mm upstream on the peripheral surface of the resilient roller from the entrance side of the nip section taking as the 0 reference the condition in which the surface of the resilient roller is in the state of not nipping the photoreceptor drum., but also the image quality after transfer was investigated closely, and conditions were found out in which there was no generation of image disturbance. The results are shown in Table 3. Pitch variations were evaluated by visual inspection in terms of three levels.

TABLE 3

| | Linear velocity (mm/sec) | | | | | | | | |
|---|---|---|---|---|---|---|---|---|---|
| | 400 | | | 500 | | | 600 | | |
| Roller type | F | G | H | F | G | H | F | G | H |
| Resilience (%) | 13 | 8 | 5 | 13 | 8 | 5 | 13 | 8 | 5 |
| Amount of depression | 0.012 | 0.022 | 0.036 | 0.021 | 0.032 | 0.05 | 0.036 | 0.064 | 0.091 |
| (mm) | | | | | | | | | |
| Rate of change of | 94 | 89 | 82 | 90 | 84 | 75 | 82 | 68 | 55 |
| deformation (%) | | | | | | | | | |
| Image disturbance | A | A | A | A | B | C | B | C | D |
| Pitch variations | B | B | B | B | B | C | B | D | D |

Evaluation of pitch variations: B: Pitch variations cannot be seen in half tone images. C: Permissible pitch variations can be viewed in half tone images. D: Pitch variations that cannot be allowed are visible in half tone images.

As is shown in Table 3, in the case in which the linear velocity of the photoreceptor drum is 400 mm/sec, pitch variations could not be observed in all types (F, G, and H) of resilient rollers. Further, in the case in which the linear velocity of the photoreceptor drum is 500 mm/sec, pitch variations could not be observed in two types (F, and G) of resilient rollers. Very slight and permissible pitch variations were found in one type (H) of resilient roller. In addition, in the case in which the linear velocity of the photoreceptor drum is 600 mm/sec, while pitch variations could not be observed in one type (F) of resilient rollers, pitch variations that cannot be allowed were observed in two types (G and H) of resilient rollers.

In other words, the image quality after transfer is good and also there are no pitch variations in the case of a resilient roller with a rate of change of deformation (has the same meaning as the rate of recovery from deformation) of 80% or more, the image quality decreases when the rate of change of deformation is 75% or less, and the reduction in image quality becomes more severe at values in the 50s of percentages.

### EXPERIMENTAL EXAMPLE 3

Further, while the rate of change of deformation becomes small as the linear speed becomes faster, as a countermeasure thereof, by making the roller diameter large thereby extending the time taken for one revolution, it is possible to make the rate of change of deformation larger by an equivalent extent. In Table 4, the linear velocity of the resilient roller was made 600 mm/sec, the rate of change of deformation was obtained at the position B when the diameters of the three types of salient rollers (F, G, and H) was made 28 mm and 32 mm in addition to 20 mm, and also, the image quality was evaluated after transfer. The rate of change of deformation was obtained at the position B using the aforementioned method with the amount of nipping of the resilient roller with respect to the photoreceptor drum being 0.2 mm as shown in the various conditions listed above. The results are shown in Table 4 including the time taken from the measurement position A to the measurement position B shown in FIG. 5.

TABLE 4

| Roller type | F | | | G | | | H | | |
|---|---|---|---|---|---|---|---|---|---|
| Resilience (%) | 13 | | | 8 | | | 5 | | |
| Roller diameter (mm) | 20 | 28 | 32 | 20 | 28 | 32 | 20 | 28 | 32 |
| Amount of depression | 0.036 | 0.028 | 0.021 | 0.064 | 0.032 | 0.026 | 0.091 | 0.037 | 0.036 |
| (mm) | | | | | | | | | |
| Rate of change of | 82.0 | 86.0 | 89.5 | 68.0 | 84.0 | 87.0 | 55.0 | 81.5 | 82.0 |
| deformation (%) | | | | | | | | | |
| Time taken from A to | 0.10 | 0.16 | 0.19 | 0.08 | 0.13 | 0.16 | 0.07 | 0.11 | 0.13 |
| B (sec) | | | | | | | | | |
| Image disturbance | B | A | A | C | B | A | D | B | A |
| Pitch variations | B | B | B | D | B | B | D | B | B |

In Table 4, the rate of change of deformation indicates the amount recovered with respect to a nipping amount (amount of digging) of 0.2 mm when the roller is nipped.

Rate of change of deformation=(amount of roller nipping−amount of depression)/(amount of roller nipping).

Evaluation of image disturbance: A: 3-point characters can be read easily. B: 3-point characters can be read but some allowable dust is present. C: 3-point characters are very slightly recognizable but dust can be seen, but there is no problem with 5-point characters. D: 3-point characters are smudged by dust.

As is shown in Table 4, in the case of all types (F, G, and H) of rollers, by making the roller external diameter 28 mm or 32 mm, it was possible to obtain a rate of change of deformation of 80% or more, and naturally, correspondingly, it was observed that even the evaluation of the image quality after transfer was high.

### EXPERIMENTAL EXAMPLE 4

Further, in a configuration in which the toner (image) is nipped by a resilient roller, it is possible to consider the toner getting adhered to the resilient roller. In order to prevent this, a conductive material was dispersed in the main material configuring the resilient roller to obtain the roller material, and ultimately, the configuration was made one in which a bias voltage with the same polarity and the same potential as those of the toner was applied to that resilient roller.

Because of this, the linear velocity of the photoreceptor drum and the resilient roller was made 400 mm/sec, and continuous printing of 5,000 sheets (continuous image formation of 5,000 sheets) with coverage of 5% was made. After that, evaluation of the image quality was made including image disturbances due to dirt on the resilient roller and the phenomenon of black dots appearing in the image after transfer caused by toner that was once adhered to the resilient roller getting adhered back onto the photoreceptor drum. The types of resilient roller were the types F, G, and H, and the experiments were conducted for the three modes of no bias voltage applied, applying the bias voltage at all times, and applying the bias voltage at every 1,000 pages (the mode of applying the bias voltage at every prescribed number of pages is hereinafter called the refresh mode). Further, the bias voltage applied was of the same polarity and potential as the toner on the photoreceptor drum. In the case of the present experiment example, the bias voltage was -600 V. The results are shown in Table 5. The image quality was evaluated by visual inspection and expressed in terms of three levels.

TABLE 5

| | | Presence or absence of bias | | | | | | | | |
|---|---|---|---|---|---|---|---|---|---|---|
| | | | | | Bias voltage applied | | | | | |
| | | No bias voltage applied | | | at all times | | | Refresh mode | | |
| Roller type | | F | G | H | F | G | H | F | G | H |
| Number | Initial state | B | B | B | B | B | B | B | B | B |
| of pages | 1000 page | B | B | C | B | B | B | B | B | C |
| printed | 2000 page | B | C | C | B | B | B | B | B | B |
| | 3000 page | C | C | D | B | B | B | C | B | C |
| | 4000 page | D | D | D | B | B | B | B | C | C |
| | 5000 page | D | D | D | B | B | B | B | B | C |

Evaluation: B: Image disturbances could not be found. C: Black dots within the allowable range were observed. D: Black dots are visible.

As is shown in Table 5, in the case when no bias voltage is applied, the black dot phenomenon was observed from about 3,000 pages, and reduction in the image quality was observed. On the other hand, in the case in which the bias voltage was applied at all times, high image quality was maintained in all the 5,000 pages. Further, in the case of the refresh mode, although images with black dots started appearing from around 2,000 pages, the number of such sheets was small, and also since they were extremely minute they were within an allowable range. From this, while the best configuration is to apply the bias voltage at all times, it was confirmed that even a refresh mode at every prescribed number of pages is useful. Further, the image quality will be further improved if the prescribed number of pages is made half that of the aforementioned number of pages.

Further, although the amount of nipping of the resilient roller with respect to the photoreceptor drum was made 0.2 mm in the above experiments, it is not necessary to restrict to this value, and it is possible to obtain results similar to the aforementioned results as long as the conditions are such that a nipping section is formed by nipping the resilient roller with the photoreceptor drum.

Although an example of the image forming apparatus being a digital color copying machine was given in the above preferred embodiment, the present invention shall not be restricted to this but even a non-color (monochrome) image forming apparatus shall be considered to be included in the scope of the present invention.

In the above preferred embodiment, at the time of nipping the toner image on the image carrier by a roller member, without the toner image on the image carrier being affected by nipping, not only by making the attraction between toner particles act in a big way, but also by aiming to flatten, it was possible to suppress the image disturbances or toner scattering that are generated related to the transfer process, thereby making it possible to obtain high image quality

What is claimed is:

1. An image forming apparatus comprising:
(a) an image carrier on which a latent image is formed;
(b) a developing section which develops the latent image on the image carrier with a toner to form a unfixed toner image;
(c) a transfer section which transfers the unfixed toner image on the image carrier to a transfer material; and
(d) a resilient roller member provided on a position downstream of the developing section and upstream of the transfer section in a rotational direction of the image carrier, which applies pressure to the image carrier and rotates in the same direction as the image carrier,
wherein when a contact portion of the resilient roller member with the image carrier becomes a non-contact state as a rotation thereof advances, the resilient roller member maintains a deformed state that is caused by the pressure, and the resilient roller member restores from the deformed state before the contact portion again comes into contact with the image carrier.

2. The image forming apparatus of claim 1, wherein when the contact portion again comes into contact with the image carrier as the rotation advances, the resilient roller member is restored from the deformed state by a predetermined amount or more.

3. The image forming apparatus of claim 2, wherein a recovery from the deformed state of the contact portion with the image carrier is made so that a pressure deformation caused by pressure immediately after the recovery of the contact portion with the image carrier from a pressure state against the image carrier, is restored by 80% or more when the contact portion again comes into contact with the image carrier.

4. The image forming apparatus of claim 1, wherein when the contact portion with the image carrier becomes a non-contact state as the rotation advances, the contact portion of the resilient roller member with the image carrier from the deformed state is restored by a predetermined amount or less.

5. The image forming apparatus of claim 1, wherein a recovery from the deformed state of the contact portion with the image carrier is made so that a deformation caused by pressure immediately after the recovery from a state of pressing against the image carrier, is restored by 10% or less.

6. The image forming apparatus of claim 1, wherein the resilient roller member has a modulus of resilience of 5 to 25%.

7. The image forming apparatus of claim 1, wherein a bias potential having a same polarity and a same voltage as those of the toner of the unfixed toner image is applied to the resilient roller member.

8. The image forming apparatus of claim 1, wherein the resilient roller member is selectively held between at a pressure applying position against the image carrier and at a receded position where the pressure is released.
